(19) United States
(12) Patent Application Publication
(10) Pub. No.: US 2018/0082049 A1
(43) Pub. Date: Mar. 22, 2018

(54) PORTABLE ELECTRONIC DEVICE

(71) Applicant: Fingerprint Cards AB, GÖTEBORG (SE)

(72) Inventors: Olis OLOFSSON, MALMÖ (SE); Sebastian WEBER, Malmö (SE)

(73) Assignee: Fingerprint Cards AB, GÖTEBORG (SE)

(21) Appl. No.: 15/710,923

(22) Filed: Sep. 21, 2017

(30) Foreign Application Priority Data
Sep. 22, 2016 (SE) 16512543

(51) Int. Cl. G06F 21/32; G06K 9/00; G07C 9/00; G06K 9/03

(52) U.S. Cl. CPC G06F 21/32; G06K 9/00912; G06K 9/60; G06K 9/036; G06K 9/0002; G07C 9/00158

(57) ABSTRACT

The present disclosure relates to an electronic device and corresponding method further enhancing how and what type of user guidance is given to a user operating a fingerprint sensor comprised with the electronic device. The present disclosure also related to a corresponding computer program product.

### CROSS REFERENCE TO RELATED APPLICATIONS

This application claims priority to Sweden Application No. 1651254-3, filed on Sep. 22, 2016, the disclosure of which is incorporated herein by reference in its entirety.

### TECHNICAL FIELD

The present disclosure relates to an electronic device and corresponding method further enhancing how and what type of user guidance is given to a user operating a fingerprint sensor comprised with the electronic device. The present disclosure also related to a corresponding computer program product.

### BACKGROUND

Various types of biometric systems are used more and more in order to provide for increased security for accessing an electronic device, thereby providing an enhanced user convenience. In particular, fingerprint sensors have been successfully integrated in such devices, for example, thanks to their small form factor, high performance and user acceptance. Among the various available fingerprint sensing principles (such as capacitive, optical, thermal, ultrasonic, etc.), capacitive sensing is most commonly used, in particular in applications where size and power consumption are important issues.

To save cost and valuable surface space, there is an effort towards smaller and smaller fingerprint sensors. In contrast to “all at once” fingerprint scanners, which capture an image of an entire fingerprint at the same time, such smaller fingerprint sensors may be substantially smaller than the user's fingerprint. By imaging only a portion of a fingerprint at any given time, the size and cost of a partial fingerprint sensor can be made considerably smaller and cheaper than that of a full fingerprint sensor. A plurality of the smaller fingerprint image portions are then combined into a complete fingerprint image, e.g. by means of feature extraction.

For allowing the smaller fingerprint image portions to be combined with each other, it is desirable if each of the fingerprint image portions has a sufficient level of quality. This typically place constrains on how the finger is contacting the fingerprint sensor. Due to various human factors issues, it is not so easy for the user to know exactly how to position his finger in relation to the fingerprint sensor, and different users will place their fingers in different ways. In order to account for this type of variation, modern partial fingerprint sensors often incorporate mechanical means for guiding the user (e.g. a depression) and/or finger position sensors to determine the finger position in relation to the fingerprint sensor.

An example of a solution to this problem is presented in WO2016137388, implementing a feedback functionality for guiding a user to correct positioning of the finger in relation to the fingerprint sensor. However, even though WO2016137388 solves many of the problems mentioned above, there would still be of interest to allow for even further targeted user guidance for instructing the user to correctly position his finger in relation to the fingerprint sensor.

### SUMMARY

In view of the above-mentioned and other drawbacks of the prior art, it is an object of the present disclosure to aid the user's placement of the finger on the fingerprint sensor by providing proper guidance for the purpose of ensuring optimal performance of interaction with the fingerprint sensor.

According to an aspect of the present disclosure, it is therefore provided a method of guiding a user of an electronic device, the electronic device comprising a display unit configured to display a graphical user interface (GUI), a fingerprint sensor having an array of pixels and configured for capturing a fingerprint representation of a fingerprint pattern of a finger of the user, and processing circuitry connected to and configured to control the operation of the display unit and the fingerprint sensor, wherein the method comprises the steps of displaying, within the GUI, a first user guidance to the user for positioning the finger at the fingerprint sensor, wherein the first user guidance is provided for positioning the finger at a first desired center portion in relation to a relative coordinate system for the fingerprint sensor, acquiring, subsequent to displaying the first user guidance, a first image using the fingerprint sensor, determining, using the processing circuitry, a first level of user conformity by correlating a position of the finger within the first image and a content of the first user guidance, displaying, within the GUI, a second user guidance to the user, wherein the second user guidance is provided for positioning the finger at a second desired center portion in relation to a relative coordinate system for the fingerprint sensor, acquiring, subsequent to displaying the second user guidance, a second image using the fingerprint sensor, determining, using the processing circuitry, a second level of user conformity by correlating a position of the finger within the second image and a content of the second user guidance and determining, using the processing circuitry, a level of user guidance influence by comparing the first and the second level of user conformity.

The present disclosure provides a solution that further specifies what and how the user is guided to in the best possible position his finger in relation to a fingerprint sensor comprised with an electronic device. By implementation of the novel concept of determining a level of user conformity and determining such a level for at least a first and a second user guidance presented to a user, it may in accordance to the present disclosure be possible how a user in fact is influenced by the user guidance. In line with the present disclosure, a level of user guidance influence level is therefore accordingly determined based on a comparison of how well the user is acting in conformity to the first and the second user guidance.

This becomes specifically interesting as the level of user guidance influence may be applied to further guiding of the user in operating the electronic device. That is, if it is determined that the user in fact is positively influenced by the user guidance and hence in fact is understanding the user guidance (typically indicated by an in comparison high level of user guidance influence), further user guidance (such as e.g. a third subsequent user guidance) may be selected to in comparison “more complicated”, and not so basic as otherwise would be necessary is the user does not really understand how to act in view of a presented user guidance (which normally would be the case if an in comparison low level of user guidance influence is determined). Thus, how well the user conforms to the received instructions will control how and/or what further information is presented to the user.

Accordingly, there is in line with the present disclosure be possible to structure the user guidance provided to the user in a form of information hierarchy, where initially basic information/guidance that is intended to be easily understood by a user is presented first. Once it is “understood” (determined) by the electronic device (based on the determined level of user guidance influence) that the user understands the information/guidance presented and acts accordingly, the user is given more detailed information that closely relates to the user's ability to conform with the provided information/guidance, preferably specifically targeted for a task at hand. By this implementation of hierarchical user guidance, it will be possible to structurally train the user to use the fingerprint sensor in the most optimal way, staring with simple instructions and continue with more complicated guidance with an improving (increasing) user guidance influence level.

The use of the fingerprint sensor may in some embodiments relate to general unlocking of the electronic device or for accessing e.g. an application installed with the device. In such an embodiment it is necessary that a fingerprint image acquired by the fingerprint sensor has an in comparison high quality to allow for fast/swift unlocking of the electronic device without having to request the user to place his finger at the fingerprint sensor for a multiple of times. Thus, if the user is “trained” using the hierarchical user guidance concept as is presented in accordance to the present disclosure, future fingerprint image acquisitions may directly be made with a higher quality as compared to if e.g. no continuous guidance (as is common in modern implementations of electronic devices comprising a fingerprint sensor) is given to the user for better understanding of how the fingerprint sensor is best used.

In line with the above, if the user has been trained to directly (once the user is to unlock the device) position his finger in an in comparison “optimal way”, it may in some implementations also be possible to allow for an increased security level (i.e. to reduce the false acceptance rate, FRR, further as compared to a normal implementation) for unlocking the electronic device, as it is previously known that the “rightful owner” of the electronic device is expected to position his finger at the fingerprint sensor in such a way that a high quality fingerprint image is to be expected, where a desirable amount of fingerprint features are to be expected and possible to use for authenticating the user.

The expression display unit should in accordance to the present disclosure be interpreted in the broadest sense, as well as how to provide a GUI. That is, the display unit may possibly comprise e.g. an LCD screen or similar. However, the display unit may alternatively be implemented using a light emitting diodes (LEDs) for providing the GUI.

In another embodiment the hierarchical user guidance concept as is presented in accordance to the present disclosure may be used for training the user for other uses of the fingerprint sensor, i.e. not only for using the fingerprint sensor to unlock the electronic device. Such uses may for example relate to using the fingerprint sensor to control a position of a “pointer/cursor” shown in the graphical user interface (GUI) provided within the display unit comprised with the electronic device. That is, in some embodiment the user may “move around” his finger at the fingerprint sensor, where the movement of the finger will reflect as movement of the pointer/cursor within the GUI. To “master” such a functionality it is normally necessary to properly train the user in correct movement patterns, how hard to place his finger at the fingerprint sensor for achieving a desirable fingerprint image quality level, where the outer boundaries of the fingerprint sensor are (what area to move the finger within), etc.

In an alternative embodiment of the present disclosure, it may additionally be possible to use the determined level of user guidance influence for defining an experience level for the user, and further use this information for selecting what information that is to be presented to the user. That is, in the most general sense of the present disclosure it is determined the user is influenced by the given instructions/guidance. On the other hand, having a high level of user guidance influence to instructions/guidance does not necessarily directly mean that the user has a high experience level. However, if adapting the method according to the present disclosure to allow for a determination of both the level of user guidance influence and how experienced the user is, it could be possible to even further guide the user in his use of the fingerprint sensor.

It should be understood that the user guidance provided to the user may be configured in many different ways to best instruct the user in how the fingerprint sensor is to be used. Possibly, the user guidance provided to the user within the GUI may accordingly comprise at least one of an animated icon, a dialogue box and an informative film. It could also be possible to provide haptic feedback to the user as part of the user guidance.

Furthermore, it should also be understood that both of the determined level of user guidance influence and the determined level of experience may be used by further components of the electronic device in giving instructions, guidance and feedback to the user. That is, if it previously has been determined a level of user guidance influence and an experience level, then subsequently used functions (possibly presented in an application running at the electronic device and possibly non-related to the fingerprint sensor) may adapt its user interface to match the determined user guidance influence and experience level. Thus, a user that has been determined to not easily understand the provided instructions may be given slightly different instructions to better handle the application.

Still further, the expression “processing circuitry” as used above should be understood to include any type of computing device, such as an ASIC, a micro-processor, etc. It should also be understood that the actual implementation of such a processing circuitry may be divided between more than a single device/circuit.

According to another aspect of the present disclosure, there is provided an electronic device, comprising a display unit configured to display a graphical user interface (GUI), a fingerprint sensor having an array of pixels and configured for capturing a fingerprint representation of a fingerprint pattern of a finger of a user, and processing circuitry electrically connected to the fingerprint sensor and the display unit, wherein the processing circuitry is configured to display, within the GUI, a first user guidance to the user for positioning the finger at the fingerprint sensor, wherein the first user guidance is provided for positioning the finger at a first desired center portion in relation to a relative coordinate system for the fingerprint sensor, acquire, subsequent to displaying the first user guidance, a first image using the fingerprint sensor, determine, using the processing circuitry, a first level of user conformity by correlating a position of the finger within the first image and a content of the first user guidance, display, within the GUI, a second user guidance to the user, wherein the second user guidance is provided for positioning the finger at a second desired center portion in relation to a relative coordinate system for the fingerprint sensor, acquiring, subsequent to displaying the second user guidance, a second image using the fingerprint sensor, determine, using the processing circuitry, a second level of user conformity by correlating a position of the finger within the second image and a content of the second user guidance, and determine, using the processing circuitry, a level of user guidance influence by comparing the first and the second level of user conformity.

According to a further aspect of the present disclosure, there is provided a computer program product comprising a non-transitory computer readable medium having stored thereon computer program means for controlling an electronic device, the electronic device comprising a fingerprint sensing system including a fingerprint sensor and processing circuitry, the fingerprint sensing system adapted for forming a fingerprint representation of a fingerprint pattern of a finger of a user, wherein the computer program product comprises code for displaying, within the GUI, a first user guidance to the user for positioning the finger at the fingerprint sensor, wherein the first user guidance is provided for positioning the finger at a first desired center portion in relation to a relative coordinate system for the fingerprint sensor, code for acquiring, subsequent to displaying the first user guidance, a first image using the fingerprint sensor, code for determining a first level of user conformity by correlating a position of the finger within the first image and a content of the first user guidance, code for displaying, within the GUI, a second user guidance to the user, wherein the second user guidance is provided for positioning the finger at a second desired center portion in relation to a relative coordinate system for the fingerprint sensor, code for acquiring, subsequent to displaying the second user guidance, a second image using the fingerprint sensor, code for determining a second level of user conformity by correlating a position of the finger within the second image and a content of the second user guidance, and code for determining a level of user guidance influence by comparing the first and the second level of user conformity.

A software executed by the server for operation in accordance to the present disclosure may be stored on a computer readable medium, being any type of memory device, including one of a removable nonvolatile random access memory, a hard disk drive, a floppy disk, a CD-ROM, a DVD-ROM, a USB memory, an SD memory card, or a similar computer readable medium known in the art.

In summary, the present disclosure generally relates to a method of guiding a user of an electronic device, the electronic device comprising a display unit configured to display a graphical user interface (GUI), a fingerprint sensor having an array of pixels and configured for capturing a fingerprint representation of a fingerprint pattern of a finger, and processing circuitry connected to and configured to control the operation of the display unit and the fingerprint sensor, wherein the method comprises the steps of displaying, within the GUI, a first user guidance to the user for positioning the finger at the fingerprint sensor, acquiring, subsequent to displaying the first user guidance, a first image using the fingerprint sensor, determining, using the processing circuitry, a first level of user conformity by correlating a position of the finger within the first image and a content of the first user guidance, displaying, within the GUI, a second user guidance to the user, acquiring, subsequent to displaying the second user guidance, a second image using the fingerprint sensor, determining, using the processing circuitry, a second level of user conformity by correlating a position of the finger within the second image and a content of the second user guidance, and determining, using the processing circuitry, a level of user guidance influence by comparing the first and the second level of user conformity.

The present disclosure provides a solution that further specifies what and how the user is instructed to position his finger in relation to a fingerprint sensor comprised with an electronic device.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIGS. 1A-1C schematically exemplifies embodiment of the electronic device according to the present disclosure, in the form of a mobile phone comprising an integrated fingerprint sensor;

FIG. 2 schematically shows the fingerprint sensor array comprised in the electronic device in FIGS. 1A-1C;

FIG. 3 conceptually illustrates a fingerprint sensor system comprised with the electronic device;

FIG. 4 is a flowchart illustrating the operation of the electronic device according to a currently preferred embodiment of the present disclosure;

FIGS. 5A-5E exemplifies the presentation of hierarchical user guidance to be presented to the user of the electronic device; and

FIG. 6 shows a possible alternative embodiment for use of the concept as defined by the present disclosure.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled person. Like reference characters refer to like elements throughout.

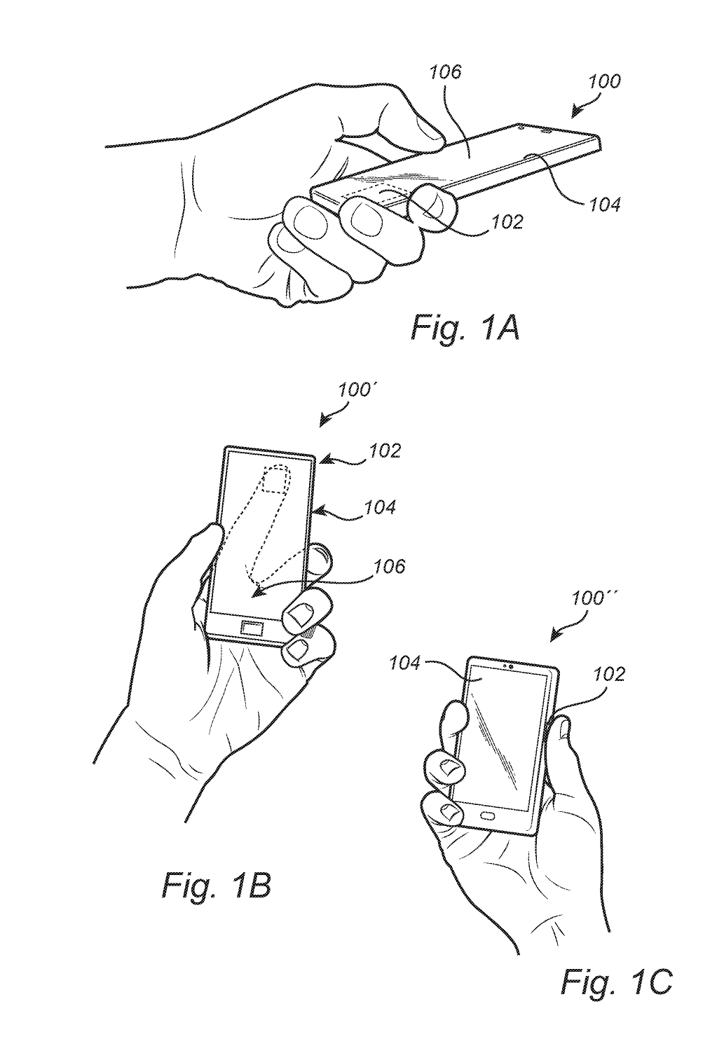

Turning now to the drawings and to FIG. 1A in particular, there is schematically illustrated an electronic device according to the present disclosure, in the form of a mobile phone 100 with an integrated fingerprint sensor 102 and a display unit 104 with a touch screen interface (graphical user interface, GUI) 106. In this embodiment the fingerprint sensor 102 and the display unit 104 are together arranged at the front side of the mobile phone 100. The fingerprint sensor 102 may, for example, be used for unlocking the mobile phone 100 and/or for authorizing transactions carried out using the mobile phone 100, etc.

FIG. 1B schematically illustrates an alternative embodiment of the electronic device according to the present disclosure, where the display unit 104 is still arranged at the front side of the mobile phone 100′, having the fingerprint sensor 102 alternatively arranged at the backside of the mobile phone 100′.

FIG. 1C schematically presents a further alternative embodiment of the electronic device according to the present disclosure, where the display unit 104 again is arranged at the front side of the mobile phone 100″, having the fingerprint sensor 102 alternatively arranged at the side of the mobile phone 100″.

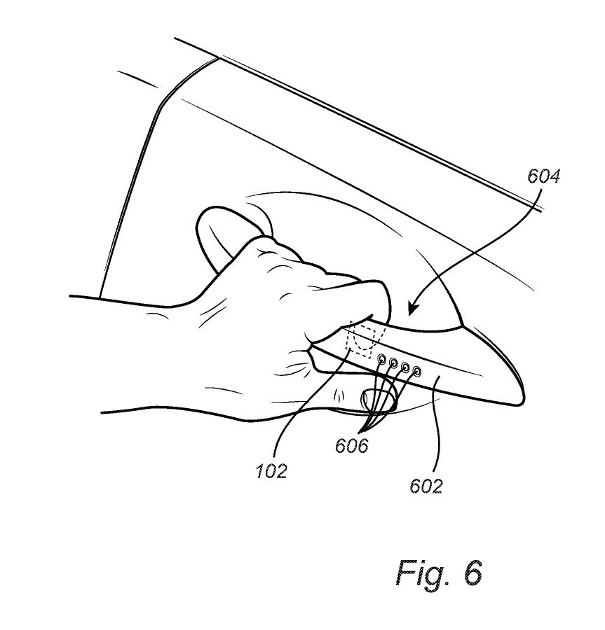

Preferably and as is apparent for the skilled person, the mobile phone 100, 100′, 100″ shown in FIGS. 1A-1C further comprises a first antenna for WLAN/Wi-Fi communication, a second antenna for telecommunication communication, a microphone, a speaker, and a phone control unit. Further hardware elements are of course possibly comprised with the mobile phone. It should furthermore be noted that the present disclosure may be applicable in relation to any other type of electronic device, such as a laptop, a remote control, a tablet computer, or any other type of present or future similarly configured device, such as exemplified in FIG. 6.

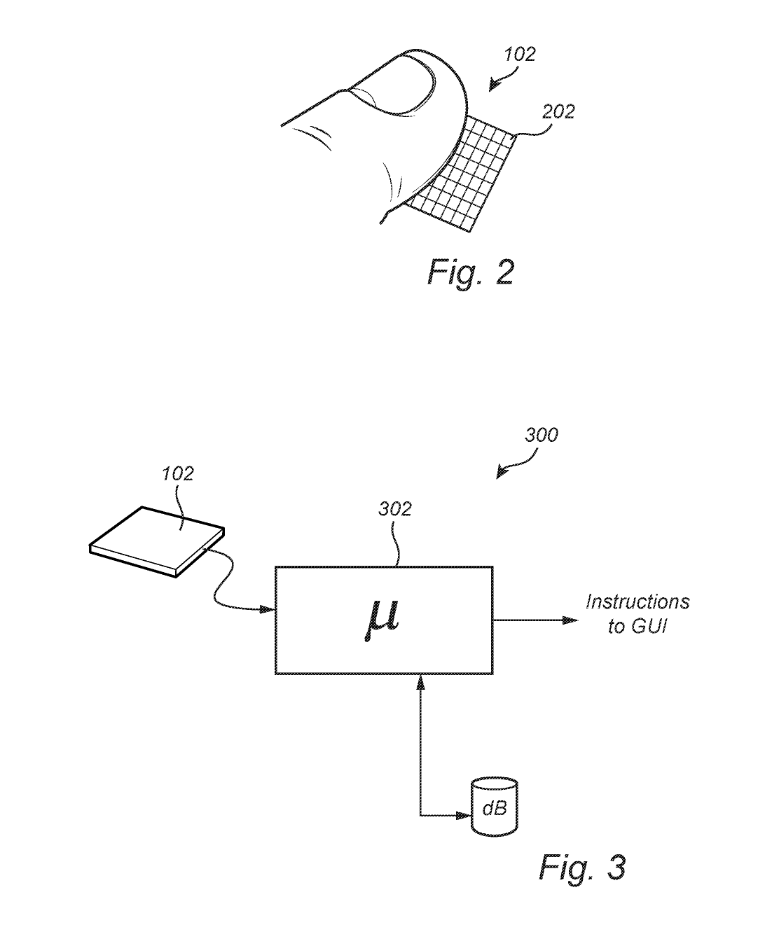

With reference to FIG. 2, there is conceptually illustrated a somewhat enlarged view of the fingerprint sensor 102. In the case of employing a capacitive sensing technology, the fingerprint sensor 102 is configured to comprise a plurality of sensing elements, preferably arranged as a two-dimensional array. A single sensing element (also denoted as a pixel) is in FIG. 2 indicated by reference numeral 202. It should however be noted understood that both one and two-dimensional sensors are possible and within the scope of the present disclosure. It is also, in accordance to the present disclosure, possible to apply the concept in relation to other types of fingerprint sensing technologies, such as for example based on optical, thermal, ultrasonic, etc. sensing.

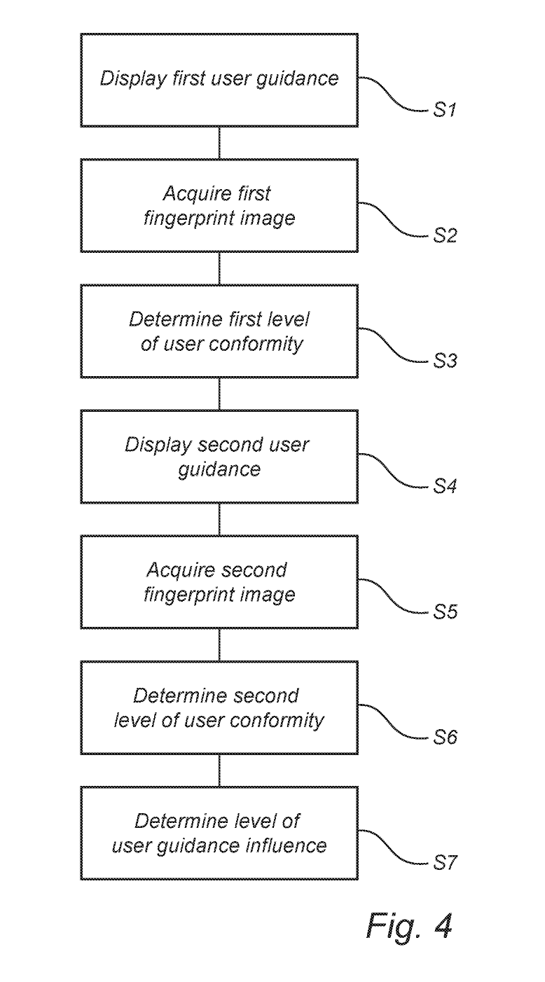

In accordance with the present disclosure, the fingerprint sensor 102 and the operation for acquiring a fingerprint image is achieved using a conceptualized fingerprint sensor system 300 as is illustrated in FIG. 3. The fingerprint sensor system 300 in turn, typically, forms part of the electronic device/mobile as is exemplified in FIGS. 1A-1C.

The fingerprint sensor system 300 comprises the fingerprint sensor 102 and a processing circuitry, such as a control unit 302 for controlling the fingerprint sensor 102. The fingerprint sensor system 300 further comprises a memory, such as a database 304, e.g. storing a fingerprint template for the user, as well as for storing user guidance data to be presented to the user using the GUI. The control unit 302 may each include a microprocessor, microcontroller, programmable digital signal processor or another programmable device. The control unit 302 may also, or instead, each include an application specific integrated circuit, a programmable gate array or programmable array logic, a programmable logic device, or a digital signal processor. Where the control unit 302 includes a programmable device such as the microprocessor, microcontroller or programmable digital signal processor mentioned above, the processor may further include computer executable code that controls operation of the programmable device. It should be understood that all or some parts of the functionality provided by means of the control unit 302 (or generally discussed as “processing circuitry”) may be at least partly integrated with the fingerprint sensor 102.

During use of e.g. the mobile phone 100, for example for unlocking the mobile phone 100, the user is required to arrange his finger onto the fingerprint sensor 102. In some implementations, the fingerprint sensor 102 may be integrated with the mobile phone 100 in such a way that it will not be readily apparent for the user exactly where on the front of the mobile phone 100 to place his finger, specifically for allowing the acquisition of a fingerprint image having a desired quality level. If the quality level is below a specified threshold, the user is generally repeatedly instructed to place his finger at the fingerprint sensor 102 until a fingerprint image having the desired quality level has been acquired. The level of quality may in one embodiment be defined as an indication of the possibility of successful feature extraction (i.e. being a representation of the fingerprint), for example, where sufficient contrast between ridges and valleys of the fingerprint is identifiable. Successful feature extraction is typically essential for achieving a successful enrollment as well as verification/authentication of the users fingerprint, e.g. for use in unlocking the mobile phone 100, for verifying a purchase, etc.

As understood, in case position of the fingerprint sensor 102 is not readily apparent for the user (such as on the back as is shown in FIG. 1b and on the side as is shown on FIG. 1C), the instruction repetition may be somewhat annoying for the user. Thus, it is desirable to give the user a firm guidance on how and where to place his finger (in relation to the fingerprint sensor 102), where the guidance is selected to correspond to the actual use of the fingerprint sensor 102.

An unapparent integration of the fingerprint sensor 102 may for example be if the fingerprint sensor is arranged to fully coincide with a front of the mobile phone 100, e.g. such that all of the front of the mobile phone 102 is “flat”, i.e. without any (or only limited) mechanical guidance for the user in using the fingerprint sensor 102.

Accordingly, it is desirable to provide sufficient, personalized and direct user guidance to the user. In addition, it is preferred if the user guidance in fact is giving the user a feeling that he is in fact is learning something from the user guidance, not being interpreted as repeated and therefore annoying.

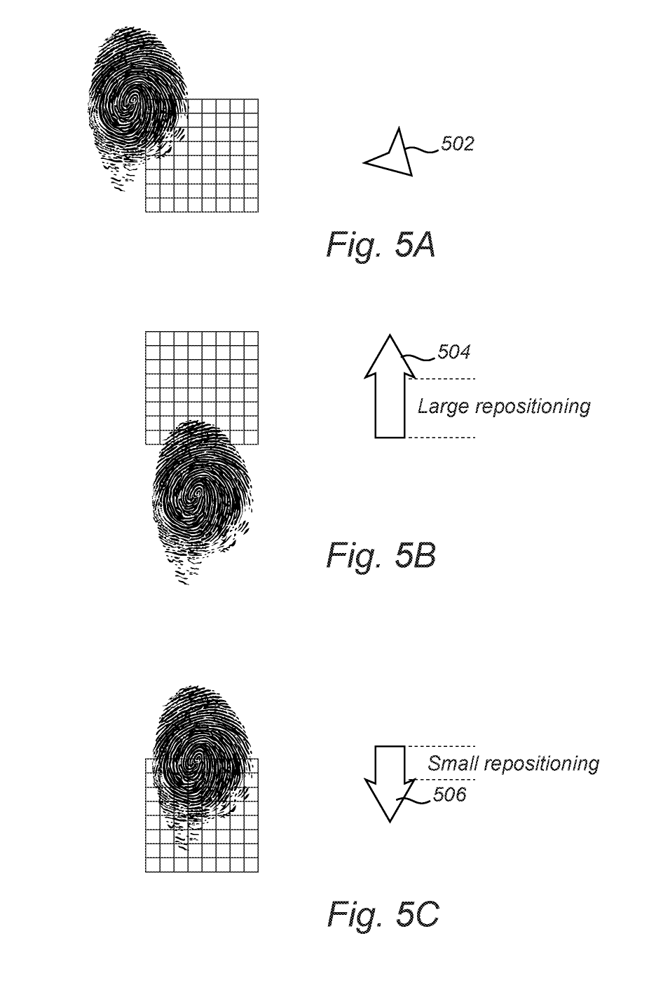

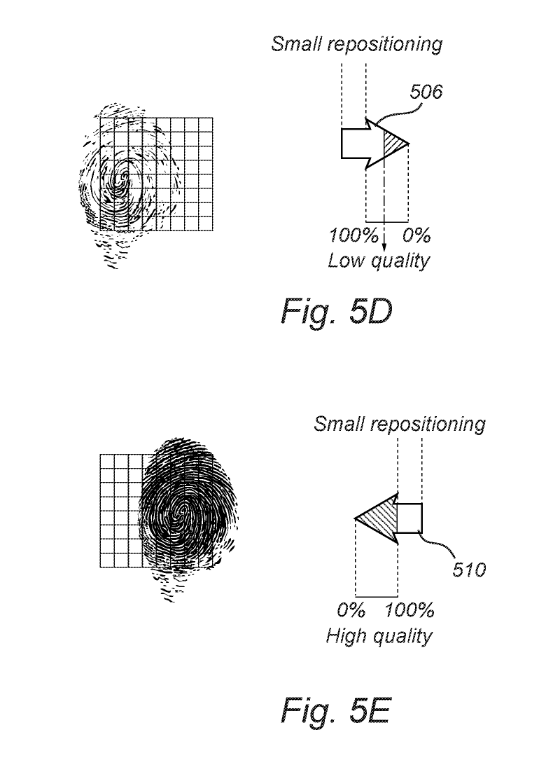

During operation of the inventive mobile phone 100, 100′, 100′, with further reference to FIGS. 4 and 5A-5E, the user is given user guidance within the GUI 106 provided at the display unit 104. The inventive methodology takes its start in an initial step S1 where the GUI 106 displays a first user guidance to the user for positioning the finger at the fingerprint sensor 102. The first user guidance may for example be presented as a written text, an icon, an animated icon, etc. Once the finger has been placed at the fingerprint sensor 102, a first image of the finger is acquired, S2, using the fingerprint sensor 102. Using the control unit 302, a first level of user conformity is determined, S3, by correlating a position of the finger within the first image and a content of the first user guidance. It should be understood that the correlation could be implemented by comparing a desired center portion for the finger in relation to a relative coordinate system for the fingerprint sensor 102 that has been conveyed using the user guidance and an actual center position of the finger as is determined from the fingerprint image.

Following this determination, a second user guidance is displayed, S4, within the GUI 106. Subsequently to displaying the second user guidance, a second image of the finger is acquired, S5, using the fingerprint sensor 102. Based on the second fingerprint image, a second level of user conformity is determined, S6, by correlating a position of the finger within the second image and a content of the second user guidance. Based on the two determinations (i.e. first and second) of user conformity, the control unit 302 subsequently determines, S7, a level of user guidance influence by comparing the first and the second level of user conformity.

In a typical implementation, if both the first level of user conformity and the second level of user conformity is above a predetermined threshold, this will generate a high level of user guidance influence, i.e. how well the (first and second) user guidance has been understood by the user. On the other hand, if both the first and the second level of user conformity are below the predetermined threshold, this will typically generate a low level of user guidance influence. Additionally, in case one of the first and the second level of user conformity is above the predetermined threshold and the other level of user conformity is below the predetermined threshold, then this typically will generate a medium level of user guidance influence. Accordingly, further user guidance provided to the user may be allowed to depend on the determined level of user guidance influence, where more in-depth user guidance typically will be given to a user having a high level of user guidance influence.

In FIGS. 5A-5E there are conceptually exemplified how user guidance possibly could be arranged in a hierarchical manner. The examples given are non-limiting and it should be understood that further information may be given, the user guidance may be presented in different ways (in addition to the icons shown in FIGS. 5A-5E), such as using video clips, tactile feedback, different colors, histograms, visualizations of acquired fingerprint images, etc.

To exemplify, in FIG. 5A there is shown an illustration of a fingerprint pattern in relation to a fingerprint sensor 102. As may be seen, the finger, and consequently the fingerprint pattern, is somewhat off center as compared to the fingerprint sensor 102, specifically somewhat to the left and to the top of the fingerprint sensor 102. Accordingly, based on a determined center point for the fingerprint pattern, the user is given a user guidance 502. The user guidance 502 is of the most basic type, typically presented to a user that has been determined to have a low level of user guidance influence. That is, in FIG. 5A only the “triangular” portion of an arrow is shown (i.e. only the arrow head), pointing in a direction towards where it is desired that the user should reposition his finger to better match the center point of the fingerprint sensor 102.

In FIG. 5B, the user has positions his finger in a relative center of the fingerprint sensor 102 but still a fairly “low” as compared to the center of the fingerprint sensor. Thus, there will be desirable if the user would reposition his finger a fair bit upwards towards the top of the fingerprint sensor 102. In the illustration provided in FIG. 5B, it has previously been determined that the user has at least a medium level of user guidance influence. Accordingly, it is consequently determined that more in-depth user guidance may be given to the user. As is illustrated in FIG. 5B, the triangular as was shown in FIG. 5A has been amended to also comprise a shaft portion, where a relative length of the shaft portion is provided as an indication of how far the finger is to be repositioned. An alternative is given in FIG. 5C where an in comparison shorter shaft portion is presented within the GUI 106, thereby giving the user an indication of that the finger only should be mover an in comparison short distance.

In addition, if it has been determined that the user has a high level of user guidance influence, it is possible to provide further information/data with the presented user guidance. In FIGS. 5D and 5E this is exemplified by providing a relative amount of “dashing” within the arrow head (only), in this embodiment providing the user with an indication of how well fingerprint features may be extracted from the acquired fingerprint image, presented as a quality metric for how well the finger for example is in contact with the fingerprint sensor 102. In FIG. 5D there is shown to be somewhat to the right of the center of the fingerprint sensor 102 and with only a limited contact with the surface area of the fingerprint sensor 102. Thus, the user guidance 508 given to the user is an indication to move his finger to the left and to rearrange the finger (e.g. press slightly harder) for providing an improved contact between the finger and the fingerprint sensor 102 to thus be able to acquire a fingerprint image having an improved quality. In FIG. 5E, the user is again instructed to move his finger (now to the left), with the further information given in that a relatively high quality fingerprint image has been acquired (i.e. the user is thus urged to position his finger in a comparable manner but slightly to the left as is indicated by the length of the shaft portion of the user guidance/arrow 510.

As indicated above the concept as provided in accordance to the present disclosure may be implemented in other types of electronic devices, i.e. not necessarily in relation to electronic devices such as mobile phones, laptops, tablets, etc. Rather, the concept as provided in line with the present disclosure may be implemented also in such an electronic device as a door handle 602 for e.g. a vehicle. In such an implementation the fingerprint sensor 102 could for example be implemented in a “hidden” manner, such as at an inside 604 of the door handle 602. The door handle may further be provided with a plurality of LEDs 606 forming the display unit adapted to present the GUI. The LEDs 606 are in such an implementation adapted to display the first and the second user guidance.

The control functionality of the present disclosure may be implemented using existing computer processors, or by a special purpose computer processor for an appropriate system, incorporated for this or another purpose, or by a hardwire system. Embodiments within the scope of the present disclosure include program products comprising machine-readable medium for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

In addition, variations to the disclosed embodiments can be understood and effected by the skilled addressee in practicing the present disclosure, from a study of the drawings, the disclosure, and the appended claims. Furthermore, in the claims, the word “comprising” does not exclude other elements or steps, and the indefinite article “a” or “an” does not exclude a plurality.

1. A method of guiding a user of an electronic device, the electronic device comprising a display unit configured to display a graphical user interface (GUI), a fingerprint sensor having an array of pixels and configured for capturing a fingerprint representation of a fingerprint pattern of a finger of the user, and processing circuitry connected to and configured to control the operation of the display unit and the fingerprint sensor, wherein the method comprises the steps of:
displaying, within the GUI, a first user guidance to the user for positioning the finger at the fingerprint sensor, wherein the first user guidance is provided for positioning the finger at a first desired center portion in relation to a relative coordinate system for the fingerprint sensor;
acquiring, subsequent to displaying the first user guidance, a first image using the fingerprint sensor;
determining, using the processing circuitry, a first level of user conformity by correlating a position of the finger within the first image and a content of the first user guidance;
displaying, within the GUI, a second user guidance to the user, wherein the second user guidance is provided for positioning the finger at a second desired center portion in relation to a relative coordinate system for the fingerprint sensor;
acquiring, subsequent to displaying the second user guidance, a second image using the fingerprint sensor;
determining, using the processing circuitry, a second level of user conformity by correlating a position of the finger within the second image and a content of the second user guidance; and
determining, using the processing circuitry, a level of user guidance influence by comparing the first and the second level of user conformity.

2. The method according to claim 1, further comprising the steps of:
selecting, using the processing circuitry, a third user guidance based on the level of user guidance influence; and
displaying, within the GUI, the third user guidance to the user.

3. The method according to claim 1, wherein the second user guidance is selected based on the first level of conformity.

4. The method according to claim 1, further comprising the steps of:
comparing the level of user guidance influence with a predefined threshold; and
defining an experience level for the user.

5. The method according to claim 4, wherein content provided with subsequent user guidance is selected based on the experience level for the user.

6. The method according to claim 4, wherein a level of details comprised with content provided with subsequent user guidance is selected to have an inverse relation to the experience level for the user.

7. The method according to claim 1, further comprising the steps of:
forming, using the processing circuitry, graphical information to be included with the second user guidance, prior to displaying the second user guidance, comprising a fingerprint image and location information relating to the position of the finger within the first image.

8. The method according to claim 1, wherein the user guidance provided to the user within the GUI comprises at least one of an animated icon, a dialogue box and an informative film.

9. The method according to claim 1, wherein the fingerprint sensor is mounted at a side of electronic device, essentially perpendicular to the display unit.

10. The method according to claim 1, wherein the display unit is arranged at a front side of the electronic device and the fingerprint sensor is mounted at a back side of the electronic device.

11. An electronic device, comprising:
a display unit configured to display a graphical user interface (GUI);
a fingerprint sensor having an array of pixels and configured for capturing a fingerprint representation of a fingerprint pattern of a finger of a user, and
processing circuitry electrically connected to the fingerprint sensor and the display unit, wherein the processing circuitry is configured to:
display, within the GUI, a first user guidance to the user for positioning the finger at the fingerprint sensor, wherein the first user guidance is provided for positioning the finger at a first desired center portion in relation to a relative coordinate system for the fingerprint sensor;
acquire, subsequent to displaying the first user guidance, a first image using the fingerprint sensor;
determine, using the processing circuitry, a first level of user conformity by correlating a position of the finger within the first image and a content of the first user guidance;
display, within the GUI, a second user guidance to the user, wherein the second user guidance is provided for positioning the finger at a second desired center portion in relation to a relative coordinate system for the fingerprint sensor;
acquire, subsequent to displaying the second user guidance, a second image using the fingerprint sensor;
determine, using the processing circuitry, a second level of user conformity by correlating a position of the finger within the second image and a content of the second user guidance; and
determine, using the processing circuitry, a level of user guidance influence by comparing the first and the second level of user conformity.

12. The electronic device according to claim 11, wherein the processing circuitry is further configured to:
select, using the processing circuitry, a third user guidance based on the level of user guidance influence; and
display, within the GUI, the third user guidance to the user.

13. The electronic device according to claim 11, wherein the processing circuitry is further configured to:
compare the level of user guidance influence with a predefined threshold; and
define an experience level for the user.

14. The electronic device according to claim 13, wherein content provided with subsequent user guidance is selected based on the experience level for the user.

15. The electronic device according to claim 13, wherein a level of details comprised with content provided with subsequent user guidance is selected to have an inverse relation to the experience level for the user.

16. The electronic device according to claim 11, wherein the user guidance provided to the user within the GUI comprises at least one of an animated icon, a dialogue box and an informative film.

17. The electronic device according to claim 11, wherein the fingerprint sensor is employing capacitive sensing technology.

18. The electronic device according to claim 11, wherein the fingerprint sensor is mounted at a side of electronic device, essentially perpendicular to the display unit.

19. The electronic device according to claim 11, wherein the display unit is arranged at a front side of the electronic device and the fingerprint sensor is mounted at a back side of the electronic device.

20. A computer program product comprising a non-transitory computer readable medium having stored thereon computer program means for controlling an electronic device, the electronic device comprising a fingerprint sensing system including a fingerprint sensor and processing circuitry, the fingerprint sensing system adapted for forming a fingerprint representation of a fingerprint pattern of a finger of a user, wherein the computer program product comprises:
code for displaying, within the GUI, a first user guidance to the user for positioning the finger at the fingerprint sensor, wherein the first user guidance is provided for positioning the finger at a first desired center portion in relation to a relative coordinate system for the fingerprint sensor;
code for acquiring, subsequent to displaying the first user guidance, a first image using the fingerprint sensor;
code for determining a first level of user conformity by correlating a position of the finger within the first image and a content of the first user guidance;
code for displaying, within the GUI, a second user guidance to the user, wherein the second user guidance is provided for positioning the finger at a second desired center portion in relation to a relative coordinate system for the fingerprint sensor;
code for acquiring, subsequent to displaying the second user guidance, a second image using the fingerprint sensor;
code for determining a second level of user conformity by correlating a position of the finger within the second image and a content of the second user guidance; and
code for determining a level of user guidance influence by comparing the first and the second level of user conformity.
